(19) United States
(12) Patent Application Publication
(10) Pub. No.: US 2014/0029513 A1
(43) Pub. Date: Jan. 30, 2014

(54) WIRELESS COMMUNICATION SYSTEM, WIRELESS COMMUNICATION METHOD, AND MOBILE TERMINAL

(71) Applicant: Hitachi, Ltd., Tokyo (JP)

(72) Inventors: YOSUKE TAKAHASHI, Kawasaki (JP); Akihiko YOSHIDA, Yokohama (JP)

(73) Assignee: Hitachi, Ltd., Tokyo (JP)

(21) Appl. No.: 13/717,070

(22) Filed: Dec. 17, 2012

(30) Foreign Application Priority Data
Dec. 20, 2011 (JP) 2011-277798

(51) Int. Cl. H04W 36/00

(52) U.S. Cl. CPC H04W 36/0005
USPC 370/328

(57) ABSTRACT

A mobile terminal includes: an LTE wireless processing unit having an LTE communication function; a wireless LAN processing unit having a wireless LAN communication function; and a terminal control unit that determines whether to use the LTE wireless processing unit or the wireless LAN processing unit and controls a function as a wireless terminal. The mobile terminal includes a base station functional unit having a communication protocol processing function of an LTE base station. Based on control of the terminal control unit, a signal generated at the base station functional unit, the signal being based on the communication protocol of the LTE base station, is stored in a wireless LAN frame, and the signal is sent to a device in the LTE core network via a wireless LAN base station.

### FIELD OF THE INVENTION

The present invention relates to a wireless communication technique and more particularly to a wireless communication technique in a wireless communication system including mobile terminals having functions to communicate with a plurality of wireless access systems.

### BACKGROUND OF THE INVENTION

In wireless communication systems, the coverage (the cell) of a base station generally called a macro base station ranges from a radius of a few hundred meters to a radius of dozens or so kilometers. Mobile network operator provide macro base stations so as to cover areas to which wireless communication services are provided. However, areas where radio waves from a base station do not tend to be delivered are generated such as indoor spaces and cell boundaries. The mobile network operator provide wireless LAN base stations at some spots in order to enable communications also in such areas where radio waves do not tend to be delivered. The coverage of the wireless LAN base station is about a few ten meters. A mobile terminal has a function to communicate with both of the macro base station and the wireless LAN base station, so that the mobile terminal can continue to communicate also in indoor spaces and cell boundaries by switching systems to connect.

As described above, for a technique in an environment including a plurality of wireless access systems, there is Japanese Unexamined Patent Application Publication No. 2010-252335. The patent document discloses a CPC (Cognitive Pilot Channel or Common Pilot Channel) that can broadcast information about a plurality of different types of wireless systems in a wireless network where these different types of wireless systems are disposed. A CPC server uses the CPC to send information about the different types of wireless systems to user equipment (UE). The UE can connect to a plurality of wireless systems, and receives information about wireless systems, frequency allocation information, and a degree of loads from the CPC server. Japanese Unexamined Patent Application Publication No. 2010-252335 describes a technique in which the UE observes the service quality of a wireless system presently connected, and uses received information to search for an optimum access system and select the optimum access system when the service quality is a predetermined threshold or less.

Moreover, in the 3GPP (the 3rd Generation Partnership Project), which is the International Organization for Standardization, a plurality of access systems are put together, and the specifications related to a core network called a connectable EPC (Evolved Packet Core) are standardized. More specifically, TS23.401 (the 3GPP standards TS23.401 V10.4.05. Chap. 3.2 Attach Procedure), which is the 3GPP standards, stipulates the procedures of wireless access such as the EPC and LTE (Long Term Evolution). Furthermore, TS23.402 (the 3GPP standards TS23.402 V10.4.06. Chap. 2.4 Initial Attach Procedure with PMIPv6 on S2a and Chained S2a and PMIP-based S8) stipulates the procedures that the UE is connected to the EPC via a WiFi base station. TS23.402 stipulates an ePDG (Evolved Packet Data Gateway), which is a device that terminates connection from a WiFi access system and connects to the EPC in order to enable connection to the EPC via a WiFi base station, and standardizes the procedures to connect to a P-GW (PDN Gateway), which is a gateway to a service network via the ePDG.

Furthermore, 3GPP TS36.300 (the 3GPP standards TS36.300 V10.4.04. Chap. 6 Support of HeNBs) stipulates the configuration and the procedures in which a base station called a HeNB (Home eNode B) is installed in ordinary households or the like and connected to the EPC through broadband IP (Internet Protocol) network channels.

### SUMMARY OF THE INVENTION

According to the method standardized by TS23.401, in the case where a UE calls and connects to a service network from a macro base station such as an LTE base station, the UE connects to a P-GW (PDN Gateway), which is a gateway to the service network, via an eNB (evolved Node B), which is a base station, and an S-GW (Serving Gateway), which is a wireless access gateway. When the UE starts to connect to the LTE base station, a UE hardware authentication process and a user authentication process are performed. The user authentication process is a process that confirms whether a user using the UE is permitted to connect to the wireless access network. The UE can connect in the case where connection is permitted as the consequence of the hardware authentication process and the user authentication process. After once connected, in the case where handover is performed between eNBs in the same wireless access system, the wireless access system can determine that the UE permitted by authentication performs handover, so that handover can be performed while maintaining data communications without the UE again performing the authentication process.

TS23.402 stipulates the procedures that a UE calls and connects to the EPC from a WiFi access system and the procedures of handover from a WiFi base station to a macro base station such as an LTE base station. When the access system is changed like handover from a WiFi wireless access system to an LTE wireless access system, it is necessary to again perform security procedures such as the hardware authentication process and the user authentication process. Therefore, in the case of performing handover necessary to change over to a different access system, there is a problem in that it takes time for a changeover.

Moreover, in the case of LTE, a device that controls call establishment via a macro base station is mobility management equipment (MME), and a device that controls call establishment from a WiFi base station is the ePDG. As described above, when wireless access systems are different, devices that control call establishment are different. Therefore, a function supported by a wireless access system is not always supported by another wireless access system. This means that a function can be used before handover between wireless access systems but the function may not be used after handover between the wireless access systems.

As described above, when handover occurs between different access systems, problems arise in that functional difference occurs between the wireless access systems and it is difficult to seamlessly provide services.

In order to solve the problems, as an example in the present invention, in a network having a plurality of wireless access systems, the devices in a core network of a first wireless access system is configured to serve base stations for both of the first wireless access system and a second wireless access system. A mobile terminal has a base station function of the first wireless access system which is used to perform call establishment when the mobile terminal calls and connects over the second wireless access system. And the mobile terminal has a switch function which selects a terminal functional unit when the mobile terminal operates in connecting to the first wireless access system. When the mobile terminal connects via the second wireless access system, the mobile terminal performs call establishment procedure to be seen as a base station of the first wireless access system by the devices in the core network. According to the present invention, it is implemented to shorten time necessary for handover that needs a changeover between access systems, and to provide seamless services with no functional difference regardless of access systems.

### BRIEF DESCRIPTION OF THE DRAWINGS

The present invention will become fully understood from the detailed description given hereinafter and the accompanying drawings, wherein:

FIG. 1 is a diagram illustrative of the configuration of a wireless communication system according to an embodiment of the present invention;

FIG. 2 is a diagram illustrative of the configuration of a UE device according to an embodiment of the present invention;

FIG. 3 is a diagram illustrative of the hardware configuration of the UE device according to an embodiment of the present invention;

FIG. 4 is a diagram of exemplary C-plane protocol stacks when connecting to an LTE wireless access system;

FIG. 5 is a diagram of exemplary U-plane protocol stacks when connecting to an LTE wireless access system;

FIG. 6 is a diagram of exemplary C-plane protocol stacks when connecting to a WiFi wireless access system according to an embodiment of the present invention;

FIG. 7 is a diagram of exemplary U-plane protocol stacks when connecting to a WiFi wireless access system according to an embodiment of the present invention;

FIG. 8 is a diagram illustrative of the sequence of a call establishment process via a WiFi wireless access system according to an embodiment of the present invention; and

FIG. 9 is a diagram of an exemplary sequence of handover from a WiFi wireless access system to an LTE wireless access system according to an embodiment of the present invention.

### DETAILED DESCRIPTION OF THE PREFERRED EMBODIMENTS

In the following, an embodiment of the present invention will be described with reference to the drawings.

In the following embodiment, an eNB, which is an LTE base station, is taken as an example as a macro base station, and a WiFi base station that supports IEEE 802.11 is taken as an example of a wireless LAN base station. An embodiment is shown and described in which two wireless access systems cover areas.

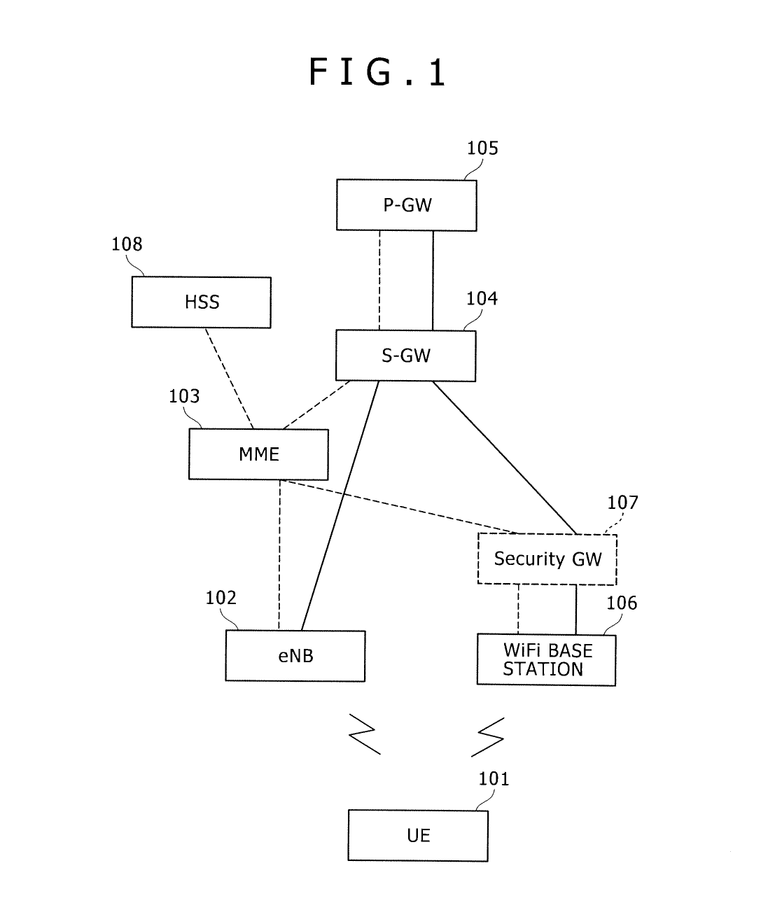

FIG. 1 is a diagram of the configuration of a wireless communication system according to an embodiment of the present invention.

FIG. 1 is a wireless communication system to which LTE wireless access and WiFi wireless access are applied as wireless access technologies.

First, the case will be described where a UE 101 performs call establishment via an eNB 102 according to an LTE wireless mode.

The UE 101 first calls and connects to the eNB 102 according to the procedures stipulated in the LTE standard. A call establishment control signal sent from the UE 101 is transferred to an MME 103 through the eNB 102. The MME 103 makes access to a home subscriber server (HSS) 108 in order to perform an authentication process that confirms whether the UE 101 is a UE permitted to establish connection to the eNB 102. After passing the authentication process, the MME 103 instructs a serving gateway (S-GW) 104 to establish user data communications. The S-GW 104 instructs a packet data network gateway (P-GW) 105 to establish connection. The P-GW 105 controls connection to a service network such as an Internet network. After completing the connection process, the UE 101 can send and receive data using an LTE wireless access system, and data sent from the UE 101 is sent to a service network via the eNB 102, the S-GW 104, and the P-GW 105.

Next, the case will be described where the UE 101 calls and connects to a WiFi base station 106 according to a WiFi wireless mode.

Prior to describing the configuration of the embodiment and the sequence of call establishment, the configuration of a conventional WiFi access system and the sequence of call establishment will be briefly described.

Conventionally, in the case of connecting to the EPC via a WiFi base station, connection is established via the ePDG as stipulated in TS23.402 (TS23.402). More specifically, a UE is connected to a WiFi base station through a wireless channel, and the WiFi base station is connected to the ePDG via an IP network such as the Internet. The ePDG is then connected to a P-GW, which is the gateway to a service network, and the UE that communicates according to the WiFi wireless mode can send data to and receive data from the service network through the P-GW.

In such a conventional configuration, although a wireless LAN system including a WiFi base station and an ePDG sends and receives data through a P-GW, the wireless LAN system configured of the ePDG, the WiFi base station, and so on is a separate, different system from the LTE wireless access system. Therefore, in the case where handover is performed from the WiFi base station of the wireless LAN system to the eNB of the LTE wireless access system, hardware authentication and user authentication are again necessary to be performed. Moreover, the function of the ePDG is different from the function of the MME, and the function supported on the LTE wireless access system side is not always provided in the wireless LAN system.

In order to solve the problems, in the embodiment, the WiFi base station is enabled to connect to the MME via the Internet. In the embodiment, for the WiFi base station, the configuration does not need to be changed, and a typical WiFi base station can be used. In order to enable the WiFi base station to connect to the MME via the Internet, the embodiment has features in the configuration of the UE. In the following, the embodiment will be described in detail.

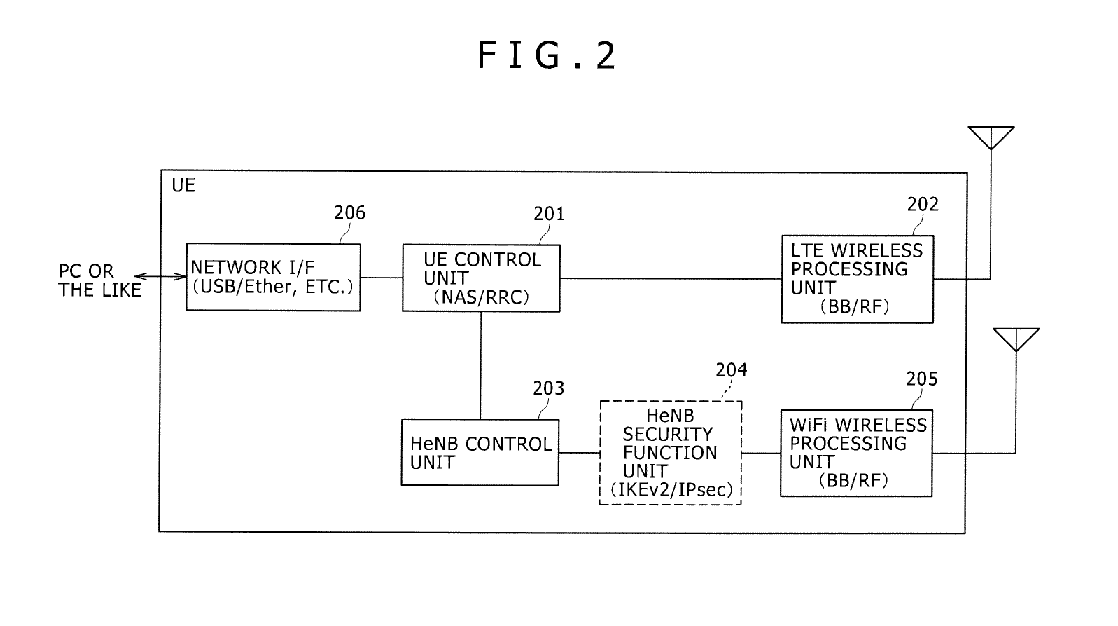

In the embodiment illustrated in FIG. 1, a call establishment control signal sent from the UE 101 is transferred from the WiFi base station 106 to the MME 103 via the Internet or the like (not shown). Here, such a configuration may be possible in which a call establishment control signal is transferred from the WiFi base station 106 to the MME 103 through a security gateway (Security GW) 107 that performs authentication processes and encryption processes such as the IPSEC. The configuration of the UE 101 and the protocol for sending a call establishment control signal from the UE 101 to the MME 103 through the WiFi base station 106 will be described with reference to FIG. 2 and the drawings after FIG. 2.

The process after the UE 101 sends a call establishment control signal to the MME 103 through the WiFi base station 106 is the same as call establishment process in the LTE wireless mode. As similar to call establishment process in the LTE wireless mode, the UE 101 send a call establishment signal to the HSS 108, the S-GW 104, and the P-GW 105, so that the UE 101 can send and receive data in the WiFi wireless mode via the WiFi base station 106. Data sent from the UE 101 is sent to and received from a service network through the WiFi base station 106, the Security GW 107, the S-GW 104, and the P-GW 105.

It is noted that in substitution for the Security GW 107, the MME 103 performs an authentication process, an encryption process, and a decryption process for the call establishment signal and the S-GW 104 performs an encryption process and a decryption process for user data, a system may be formed omitting the Security GW107. In FIG. 1, the Security GW 107 is indicated by dotted lines because the Security GW 107 can be omitted. In the description of the embodiment later, we show a system in which the function of the Security GW 107 is performed at the MME 103 and the S-GW 104, and in which the Security GW 107 is omitted.

Next, the configuration of the UE will be described.

FIG. 2 is a diagram of the configuration of the UE according to an embodiment of the present invention.

As illustrated in FIG. 2, the UE 101 according to the embodiment includes a network interface (such as a USB and Ethernet) 206, a UE control unit (NAS/RRC) 201, an LTE wireless processing unit (BB/RF) 202, a HeNB control unit 203, a HeNB security function unit (IKEv2/the IPSEC) 204, a WiFi wireless processing unit (BB/RF) 205, and antennas.

The UE control unit 201 includes a function to determine whether to perform call establishment in the LTE wireless mode or in the WiFi wireless mode and a function to control call establishment to the wireless access systems.

In the case where the UE control unit 201 determines to control calling and connection to the LTE wireless access system, the UE control unit 201 performs radio modulation for data at the LTE wireless processing unit 202, and sends the data to the eNB 102. Moreover, the UE control unit 201 demodulates the radio signal received from the eNB 102, and receives data. In the case where the UE control unit 201 determines to control calling and connection to the WiFi wireless access system, the UE control unit 201 performs radio modulation for data at the WiFi wireless processing unit 205, and sends the data to the WiFi base station 106. On the other hand, the UE control unit 201 demodulates the radio signal received from the WiFi base station, and receives data.

The HeNB control unit 203 is a configuration for performing the call establishment process with the MME 103 through the WiFi wireless processing unit 205 and the WiFi base station 106. In the embodiment, the UE 101 include a terminal function as well as a call establishment processing function included in the HeNB, and the UE 101 can send a calling establishment message that the HeNB sends to the MME 103. The call establishment message sent from the UE 101 is delivered to the MME 103 through the WiFi base station via the Internet or the like. The MME 103 considers the UE 101 as a HeNB, and calls and connects to the UE 101.

In the embodiment, the WiFi base station is used as a unit that the UE 101 connects to the MME 103 via the Internet or the like. When the EPC including the MME 103 sees the UE 101, which is including the call establishment function of the HeNB, seems to be one HeNB in the LTE wireless access system and the UE 101 seems to connect to the HeNB. In the embodiment, the UE 101 is formed in the disclosed configuration, and the WiFi base station is used as a unit to connect to the Internet, so that the WiFi base station can be included in the LTE wireless access system. Thus, even though the UE performs handover from the WiFi base station to the eNB and the operation of the UE is switched to a general LTE terminal, the handover is the handover in the LTE wireless access system, causing no hardware authentication and no user authentication. Moreover, functional difference does not occur as well.

In the case where it is necessary to secure security between the UE 101 and the MME 103 and between the UE 101 and the S-GW 104, the UE 101 is provided with the HeNB security function unit 204 to apply the IKEv2 (Internet Key Exchange version 2) and the IPSEC (Security Architecture for Internet Protocol), which are protocols to provide an anti-tampering function for data and a concealment function in units of IP packets using cryptography techniques between the UE 101 and the Security GW 107. An external terminal such as a PC that makes access to a service network communicates with the P-GW 105 through the network I/F 206 via the LTE wireless access system and the WiFi wireless access system.

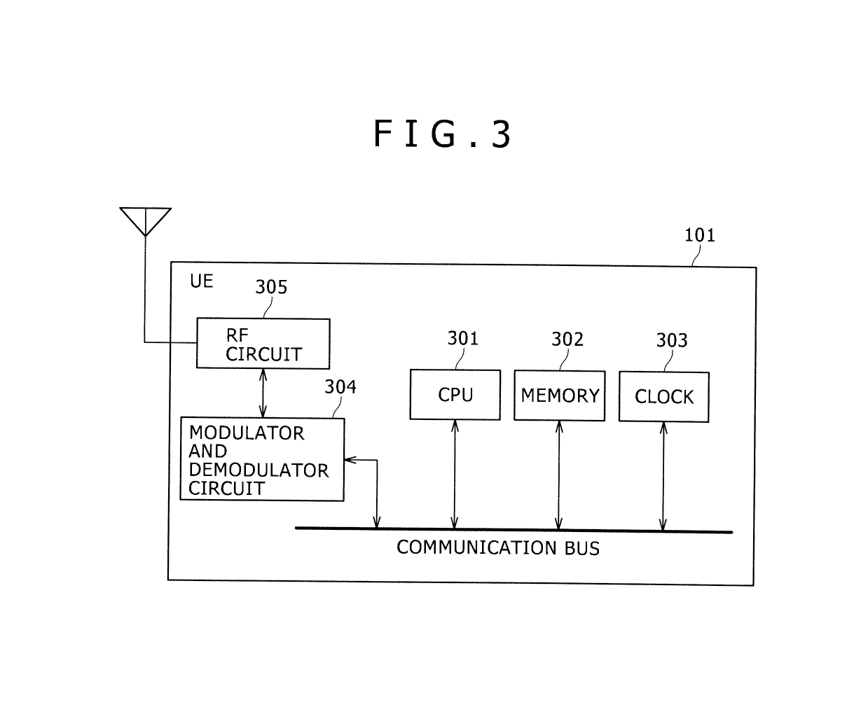

FIG. 3 is a diagram illustrative of the hardware configuration of the UE according to an embodiment of the present invention.

The UE 101 has a configuration in which a CPU 301, a memory 302, and a clock 303 are connected to a communication bus. The CPU 301 performs the processes performed at the UE control unit 201, the HeNB control unit 202, and the HeNB security function unit 204 described in FIG. 2. Transmission data processed at the CPU 301 is temporarily stored in the memory 302. A modulator and demodulator circuit 304 reads transmission data out of the memory 302 for modulating the transmission data. An RF circuit 305 converts the modulated transmission data into a radio signal, and sends the radio signal to the eNB 102 and the WiFi base station 106.

Next, protocol stacks are shown, and the embodiment of the present invention will be described.

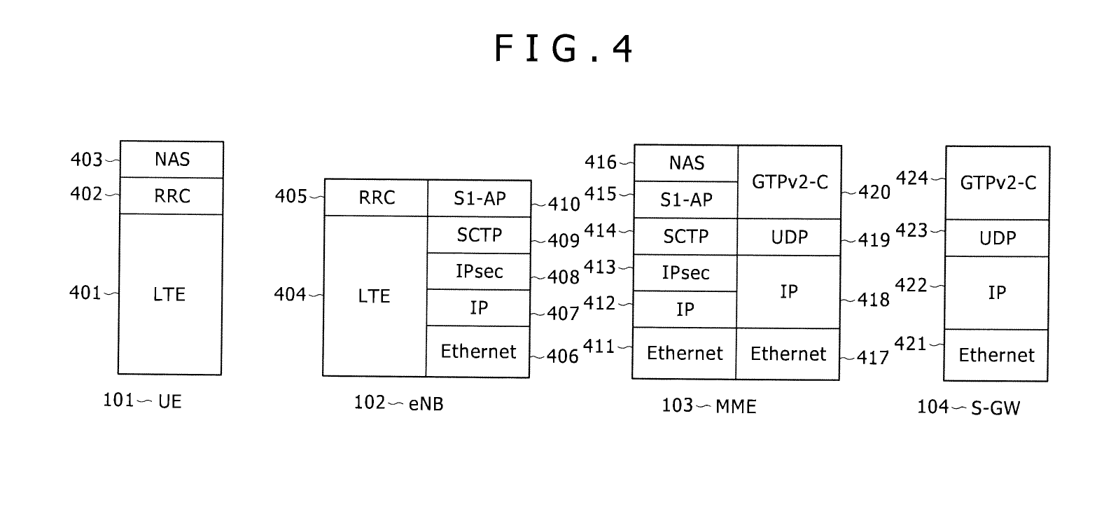

FIG. 4 is a diagram of the protocol stacks of protocols for use in sending a call processing signal for call establishment via the LTE wireless access system.

The UE 101 first sends a call processing signal using a NAS (Non-Access Stratum) 403, which is a protocol used for connecting a packet call or the like between the UE 101 and the core network.

A NAS signal is encapsulated at an RRC (Radio Resource Control) 402, which is a protocol to control wireless communications such as allocation of a channel in a radio section between the UE 101 and the eNB 102, the NAS signal is converted into a wireless frame at an LTE 401, and then the NAS signal is sent to the eNB 102. The RRC 402 is a protocol that also performs a process for establishing radio channel connection between the UE 101 and the eNB 102, a handover process to another eNB, and a release process. When the eNB 102 receives the LTE wireless frame from the UE 101, the eNB 102 performs a reception process at an LTE 404, and transfers the NAS signal to an RRC 405.

As described above, the call processing signal generated at the UE 101 using the NAS 403 is received at the RRC 405 of the eNB 102. The eNB 102 does not interpret the received call processing signal, and encapsulates the received call processing signal at an S1-AP (S1 Application Protocol) 410, which is a protocol to stipulate functions necessary between the base station and the MME 103 in the LTE wireless access system in order to transfer the received call processing signal to the MME 103. Subsequently, security is secured using an SCTP (Stream Control Transmission Protocol) 409 and an IPSEC 408, and then the received call processing signal is framed. The framed call processing signal is sent to the MME 103 through protocol processes at an IP 407 and an Ethernet 406.

The MME 103 deframes the received call processing signal through protocol processes at an Ethernet (trademark) 411, an IP 412, an IPSEC 413, an SCTP 414, and an S1-AP 415, and transfers the received call processing signal to a configuration in which an NAS 416 protocol process is performed. As described above, the call processing signal sent from the NAS 403 of the UE 101 is sent to the NAS 416 of the MME 103. The call processing signal is sent from the NAS 416 of the MME 103 to the NAS 403 of the UE 101 according to the similar method. In other words, the call processing signal is logically sent and received between the NAS 403 of the UE 101 and the NAS 416 of the MME 103, and processing procedures such as a call establishment process, a call release process, and so on are performed between the UE 101 and the MME 103.

Subsequently, the MME 103 sets a U-plane to transfer user data between the UE 101, the eNB 102, and the S-GW 104. For the U-plane setting process, a GTPv2-C 420 of the MME 103 sends and receives the call processing signal to and from a GTPv2-C 424 of the S-GW 104. The GTPv2-C 420 of the MME 103 and the GTPv2-C 424 of the S-GW 104 send and receive the call processing signal through a UDP 419, an IP 418, and an Ethernet 417 of the MME 103, and an Ethernet 421, an IP 422, and a UDP 423 of the S-GW 104.

FIG. 4 exemplifies the protocol stacks in the case where the IPSEC 408 and the IPSEC 413 are applied for securing security. However, in the case where security is secured according to another method or in the case where it is unnecessary to secure security according to a security policy, a protocol stack structure to which the IPSEC is not applied may be possible.

Next, protocol stacks applied in transferring user data in the LTE wireless access system will be described.

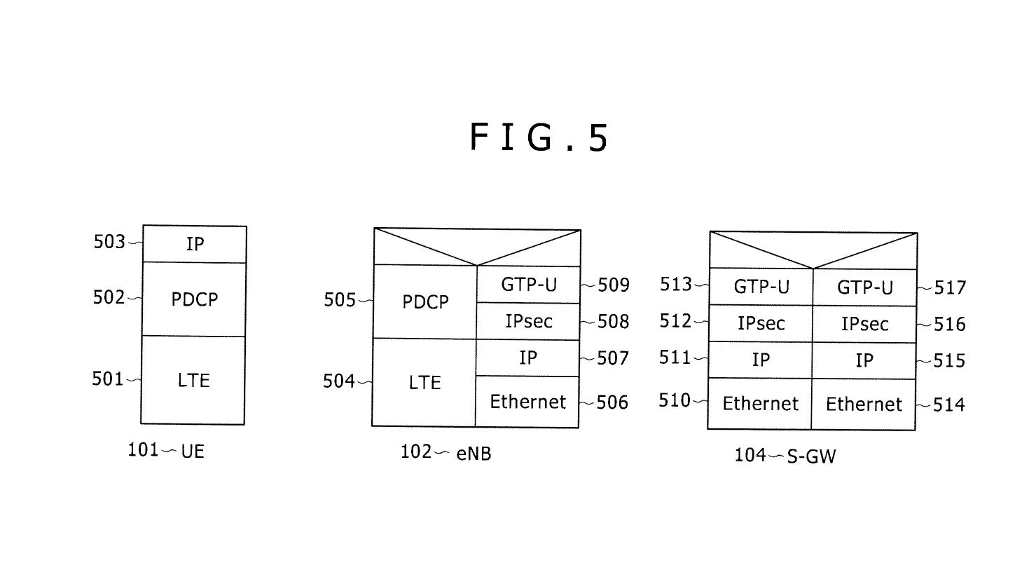

FIG. 5 is a diagram of protocol stacks applied in transferring user data in the LTE wireless access system.

In sending user data, the UE 101 generates an IP packet at an IP 503, encapsulates the IP packet at a PDCP 502, converts the IP packet into an LTE wireless frame at an LTE 501, and sends the IP packet to the eNB 102. When the eNB 102 receives the LTE wireless frame from the UE 101, the eNB 102 performs a reception process at an LTE 504, and transfers user data to a PDCP 505. The IP packet generated at the IP 503 of the UE 101 is received at the PDCP 505 of the eNB 102. The PDCP 505 of the eNB 102 does not interpret the IP packet, and transfers the IP packet to the S-GW 104 through a GTP-U 509, an IPSEC 508, an IP 507, and an Ethernet 506 in order to transfer the IP packet to the S-GW 104. The S-GW 104 deframes the received data through an Ethernet 510, an IP 511, an IPSEC 512, and a GTP-U 513, and sends the IP packet including the user data to the P-GW 105 through a GTP-U 517, an IPSEC 516, an IP 515, and an Ethernet 514. Here, FIG. 5 exemplifies the protocol stacks in the case where the IPSEC 508 and the IPSEC 512 are applied for securing security. However, in the case where security is secured according to another method or in the case where it is unnecessary to secure security according to a security policy, a protocol stack structure to which the IPSEC is not applied may be possible.

Next, protocol stacks for use in transmitting a call processing signal to the WiFi wireless access system will be described.

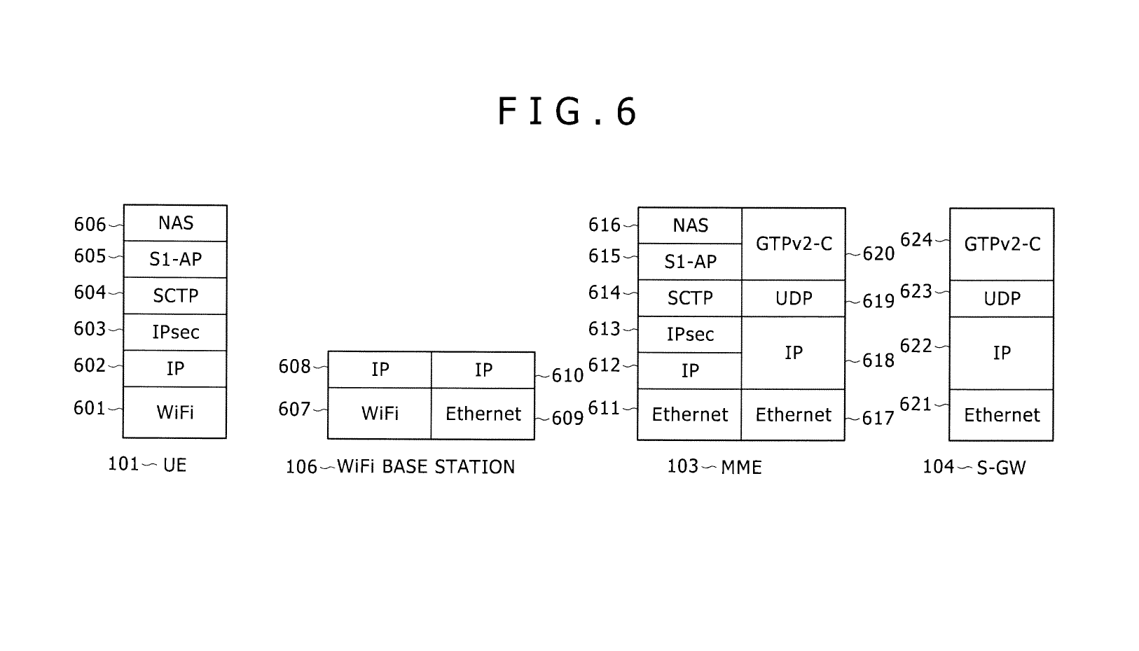

FIG. 6 is a diagram of protocol stacks for use in transmitting a call processing signal to the WiFi wireless access system according to an embodiment of the present invention.

As described in FIG. 2, the UE 101 according to the embodiment includes the UE control unit 201 that is the function included in a typical UE 101 and the function to determine whether to use the LTE wireless access system or the WiFi wireless access system. In addition, the UE 101 according to the embodiment include the HeNB control unit 203 that implements the eNB function of the LTE wireless access system. Therefore, the UE 101 according to the embodiment can also perform the sending and receiving process for the call processing signal which is performed in the eNB illustrated in FIG. 4 for itself. When the UE 101 is provided with the functions of the UE and of the eNB of the LTE wireless access system, the UE can send a call establishment signal of the LTE wireless access system to the WiFi base station in a WiFi wireless frame, thus a call establishment signal of the LTE wireless access system can be sent to the ME 103 via the WiFi base station 106, the Internet, and the like. The WiFi base station 106 may be a typical WiFi base station. When the UE 101 is seen from the MME 103, the UE 101 seems to be a HeNB connected to the UE 101, and the UE 101 can be managed as a base station and a mobile terminal in the LTE wireless access system.

Specific protocol stacks are illustrated, and the calling and connection process via the WiFi wireless access system will be described.

When a NAS 606 that performs the connection process with the MME 103 sends a call processing signal, an S1-AP 605 encapsulates an NAS signal. The encapsulated NAS signal is converted into a WiFi wireless frame at an SCTP 604, an IPSEC 603, an IP 602, and a WiFi 601, and sent to the WiFi base station 106. The WiFi base station 106 receives data at a WiFi 607 and an IP 608, and sends the received data to the MME 103 through an IP 610 and an Ethernet 611. The MME 103 deframes the received data through the Ethernet 611, an IP 612, an IPSEC 613, an SCTP 614, and an S1-AP 615, and transfers the call processing signal to a NAS 616. As described above, the call processing signal sent from the NAS 606 of the UE 101 is sent to the NAS 616 of the MME 103. The call processing signal is sent from the NAS 616 of the MME 103 to the NAS 606 of the UE 101 according to the similar method. In other words, the call processing signal is logically sent and received between the NAS 606 of the UE 101 and the NAS 616 of the MME 103, and call processing procedures such as the call establishment process and the call release process are performed between the UE 101 and the MME 103.

Subsequently, the MME 103 sets a U-plane to transfer user data between the UE 101, the WiFi base station 106, and the S-GW 104. The MME 103 and the S-GW 104 send and receive the call processing signal between a GTPv2-C 620 of the MME 103 and a GTPv2-C 624 of the S-GW 104 through a UDP 619, an IP 618, and an Ethernet 617 of the MME 103, and an Ethernet 621, an IP 622, and a UDP 623 of the S-GW 104.

FIG. 6 exemplifies the protocol stacks in the case where the IPSEC 603 and the IPSEC 613 are applied for securing security. However, in the case where security is secured according to another method or in the case where it is unnecessary to secure security according to a security policy, a protocol stack structure to which the IPSEC is not applied may be possible.

Here, the protocol stack held at the MME 103 for call establishment in the LTE wireless access system described in FIG. 4 is compared with the protocol stack held at the MME 103 for call establishment in the WiFi wireless access system in FIG. 6.

The protocol stack (the NAS 616, the S1-AP 615, the S1-AP 614, the IPSEC 613, the IP 612, and the Ethernet 611) held at the MME 103 for call establishment in the WiFi wireless access system in FIG. 6 has the same structure as the structure of the protocol stack (the NAS 416, the S1-AP 415, the SCTP 414, the IPSEC 413, the IP 412, and the Ethernet 411) held at the MME 103 for call establishment in the LTE wireless access system in FIG. 4. This shows that the same logic can be applied regardless of the types of wireless accesses.

Moreover, another feature according to the embodiment shown from the comparison between the protocol stack structures in FIG. 4 and FIG. 6 is in that the function of encapsulating the NAS signal sent from the UE 101 in FIG. 4 by the eNB 102 using the S1-AP 410 and the SCTP 409 is the protocol stack configuration (the NAS 606, the S1-AP 605, and the SCTP 604) implemented in the UE 101 in communications with the WiFi wireless access system in FIG. 6. Therefore, in the MME 103, the NAS signal received from the eNB 102 in FIG. 4 and the NAS signal received from the UE 101 in FIG. 6 can be processed in the same protocol stack.

Next, the configuration of protocol stacks applied in transferring user data in the WiFi wireless access system will be described.

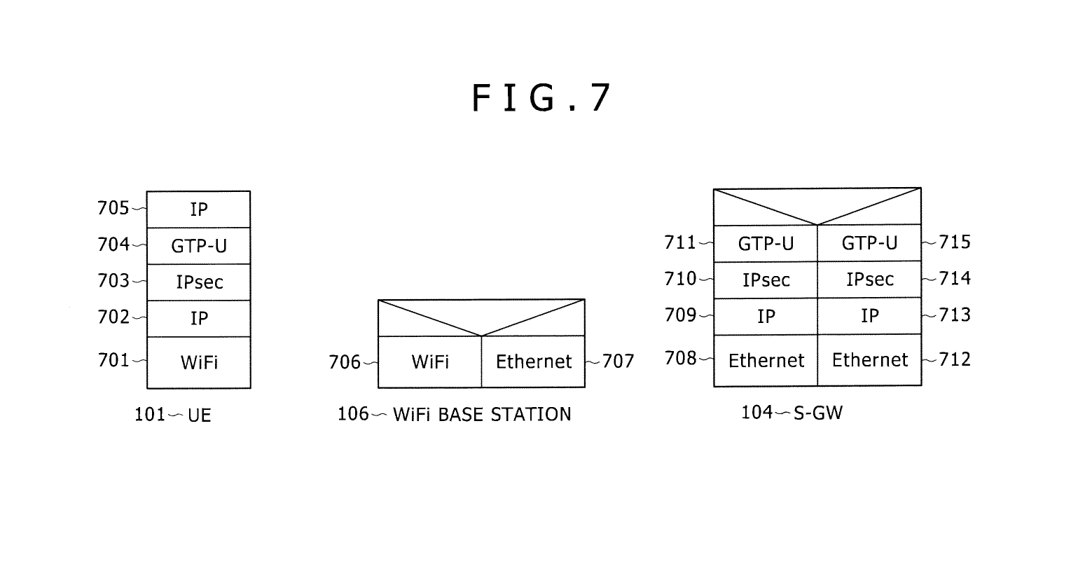

FIG. 7 is a diagram of protocol stacks applied in transferring user data in the WiFi wireless access system.

In sending user data, the UE 101 generates an IP packet at an IP 705, encapsulates the IP packet at a GTP-U 704, an IPSEC 703, and an IP 702, converts the IP packet into a WiFi wireless frame at a WiFi 701, and sends the IP packet to the WiFi base station 106. When the WiFi base station 106 receives the WiFi wireless frame from the UE 101, the WiFi base station 106 performs a reception process at a WiFi 706, and transfers user data to the S-GW 104 through an Ethernet 707. The S-GW 104 deframes the received data through an Ethernet 708, an IP 709, an IPSEC 710, and a GTP-U 711, and sends the IP packet including the user data to the P-GW 105 through a GTP-U 715, an IPSEC 714, an IP 713, and an Ethernet 712.

FIG. 7 exemplifies the protocol stacks in the case where the IPSEC 703, the IPSEC 710, and the IPSEC 714 are applied for securing security. However, in the case where security is secured according to another method or in the case where it is unnecessary to secure security according to a security policy, a protocol stack structure to which the IPSEC is not applied may be possible.

Here, the protocol stack held at the S-GW 104 for transferring user data in the LTE wireless access system illustrated in FIG. 5 is compared with the protocol stack held at the S-GW 104 for transferring user data in the WiFi wireless access system in FIG. 7.

The protocol stack (the GTP-U 711, the IPSEC 710, the IP 709, and the Ethernet 708) held at the S-GW 104 for transferring user data in the WiFi wireless access system in FIG. 7 has the same structure as the structure of the protocol stack (the GTP-U 513, the IPSEC 512, the IP 511, and the Ethernet 510) held at the S-GW 104 for transferring user data in the LTE wireless access system in FIG. 5. This shows that the same logic can be applied regardless of the types of wireless accesses. Moreover, another feature of the protocol stack structure according to the embodiment shown from the comparison between FIG. 5 and FIG. 7 is in that the function of encapsulating the IP packet generated at the UE 101 in FIG. 5 by the eNB 102 using the GTP-U 509 is the protocol stack configuration (the IP 705 and the GTP-U 704) implemented in the UE 101 in FIG. 7. Therefore, in the MME 103, the IP packet received from the eNB 102 in FIG. 5 and the IP packet received from the UE 101 in FIG. 7 can be processed in the same protocol stack.

Next, the call establishment process will be described with reference to a sequence diagram.

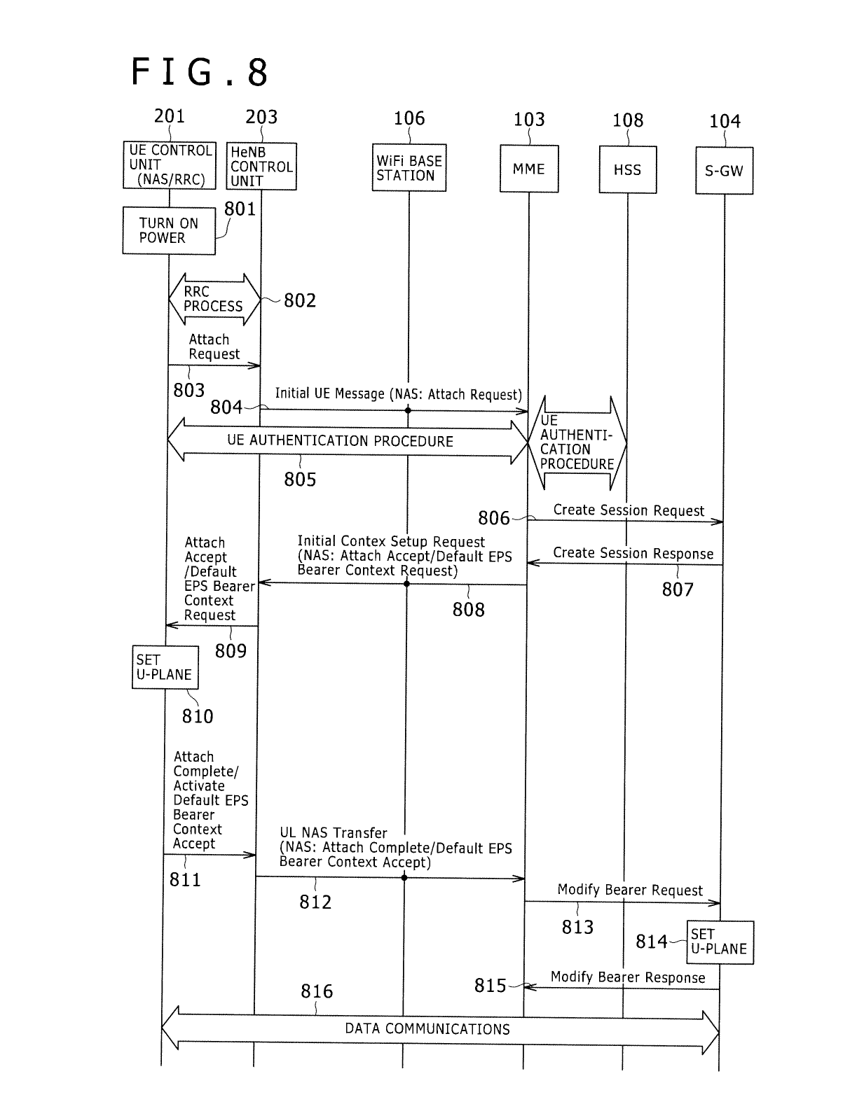

FIG. 8 is a call flow in call establishment by the UE 101 via the WiFi wireless access system.

When the UE control unit 201 of the UE 101 turns on a power supply (801), the UE control unit 201 performs an RRC connection process with the HeNB control unit 203 (802). The UE control unit 201 RRC-encapsulates an Attach Request message, which is a NAS signal, and sends the Attach Request message to the HeNB control unit 203 (803). The HeNB control unit 203 includes the Attach Request message, which is a NAS signal, in an Initial UE Message, which is an S1-AP signal, and sends the Initial UE Message to the MME 103 via the WiFi base station 106 and the Internet (804). Subsequently, a UE authentication procedure is performed between the UE control unit 201, the MME 103, and the HSS 108 (805).

When it is determined that the UE 101 is connectable to the MME 103 in the authentication process, the MME 103 sends a Create Session Request message to the S-GW 104 for setting a U-plane (806).

The S-GW 104 reserves a resource for the U-plane, and includes resource information including a TEID (Terminal Equipment ID), which is the identifier of the resource, in a Create Session Response, and sends the Create Session Response to the MME 103 (807).

The MME 103 sends an Initial Context Setup Request message, which is an S1-AP signal including an Attach Accept message and a Default EPS Bearer Context Request message as NAS signals, to the HeNB control unit 203 through the WiFi base station 106, notifies that connection is permitted to a connection request in the procedure 804, and instructs that the U-plane is set (808).

The HeNB control unit 203 RRC-encapsulates the Attach Accept message and the Default EPS Bearer Context Request message, which are the received NAS signals, and sends the messages to the UE control unit (809). The UE 101 sets the U-plane (810), RRC-encapsulates an Attach Complete message and an Activate Default EPS Bearer Context Accept message as NAS signals for notifying the completion of setting the U-plane, and sends the messages to the HeNB control unit 203 (811). The HeNB control unit 203 includes the NAS signals received from the UE control unit 201 in a UL NAS Transfer message, which is an S1-AP signal, and sends the message to the MME 103 through the WiFi base station 106.

In order to complete the setting of the U-plane, the MME 103 sends a Modify Bearer Request message to the S-GW 104 (813).

The S-GW 104 completes the setting of the U-plane (814), and sends a Modify Bearer Response message to the MME 103 (815).

The procedures described above are performed, so that the call establishment process to the EPC can be performed in the WiFi wireless access system using the configuration of the embodiment. It is noted that NAS signal processing and S1-AP signal processing applied in the process are operated in compliance with TS23.401, which is the 3GPP standard specification.

Moreover, in FIG. 8, RRC signal processing is applied between the UE control unit 201 and the HeNB control unit 203 as an example. However, RRC signal processing is a protocol originally for the radio section between the UE and the eNB, and stipulates a large number of sequences and parameters to control wireless communications. In the embodiment, a single UE is provided with the UE control unit that implements the terminal function and the HeNB control unit that implements the base station function, and the UE control unit is connected to the HeNB control unit with a cable, so that sequences and parameters to control wireless communications are unnecessary. Therefore, the NAS signal may be transmitted between the UE control unit 201 and the HeNB control unit 203 with an original signal defined, not actually applying RRC signal processing.

Next, a sequence will be described in the case where handover accompanying a wireless system changeover from the WiFi wireless access system to the LTE wireless access system occurs.

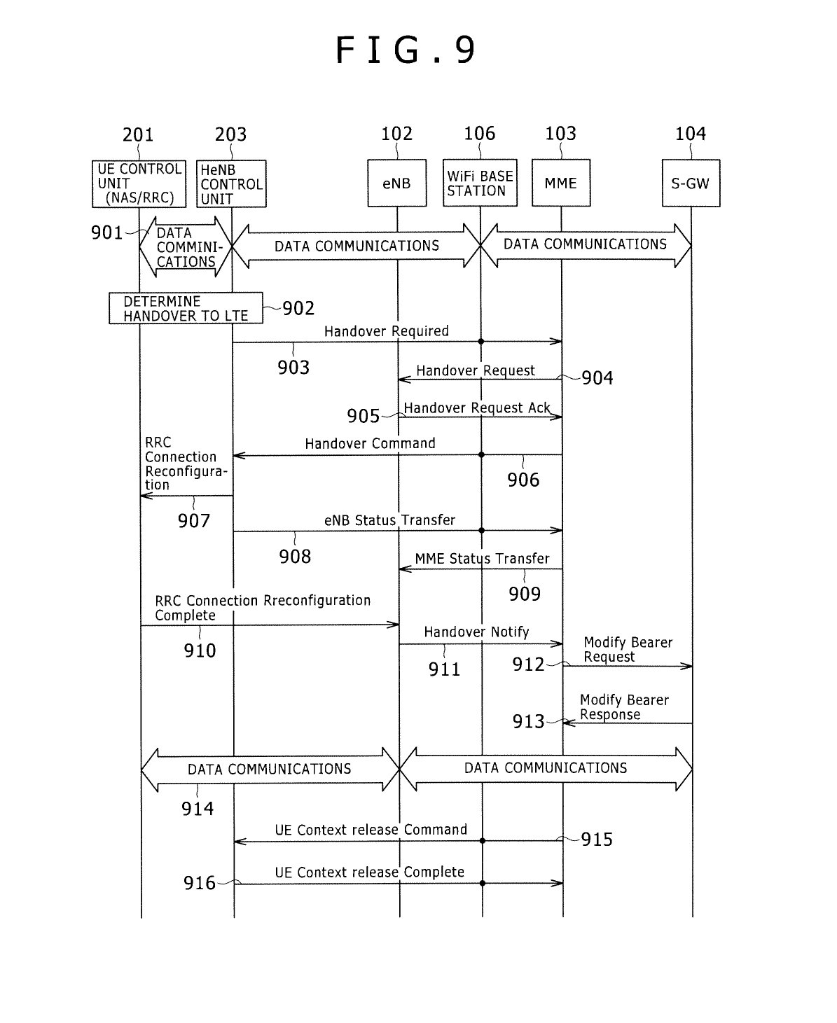

FIG. 9 is a diagram of a call flow in the case of performing handover accompanying a wireless system changeover to the LTE wireless access system after the UE 101 calls and connects to the WiFi wireless access system.

In a sequence diagram in FIG. 9, the UE 101 completes the setting of the U-plane so as to transfer user data to the S-GW 104 through the UE control unit 201, the HeNB control unit 203, and the WiFi base station 106 (901).

The UE 101 determines to perform a wireless system changeover to the LTE wireless access system (902). This determination is made in the case where the received signal quality of the LTE wireless system monitored by the LTE wireless processing unit 202 is compared with the received signal quality of the WiFi wireless system monitored by the WiFi wireless processing unit 205 and it is determined that the received signal quality of the LTE wireless system is better than two times the received signal quality of the WiFi wireless system (or as compared with criterion stipulated in advance), for example, and then a changeover to the LTE wireless access system is performed. Here, received signal quality can be applied using the power of the received signal such as RSSI (Received Signal Strength Indication) and signal quality such as a signal-to-noise ratio as parameters.

In order to perform handover, the HeNB control unit 203 sends a Handover Required message to the MME 103 through the WiFi base station 106 (903).

The MME 103 sends a Handover Request message to a handover destination eNB 102, and instructs the eNB 102 to prepare handover (904). The eNB 102 prepares the receiving of the handover to the UE 101 such as reserving radio resources, and sends a Handover Request Ack message to the MME 103 (905).

The MME 103 sends, to the HeNB control unit 203, a Handover Command message that instructs handover to the UE 101, through the WiFi base station 106 (906).

The HeNB control unit 203 sends an RRC Connection Reconfiguration message to the UE control unit 201 in order to transmit information received from the Handover Command message as information necessary for handover (907).

The HeNB control unit 203 sends, to the MME 103 through the WiFi base station 106, an eNB Status Transfer message bearing information such as the sequence number of a wireless frame necessary to continue communications with the UE 101 at the handover destination eNB 102 (908).

The MME 103 sends an MME Status Transfer message to the eNB 102 in order to transfer information received from the eNB Status Transfer message to the handover destination eNB 102 (909).

When the UE control unit 201 receives the RRC Connection Reconfiguration message at the procedure 907, the UE control unit 201 changes over wireless connection from the WiFi wireless access system to the LTE wireless access system. The UE control unit 201 synchronizes wireless connection with the eNB 102, and then sends an RRC Connection Reconfiguration Complete message to the eNB 102 (910).

The eNB 102 sends a Handover Notify message to the MME 103 in order to notify that the handover process is completed (911).

The MME 103 sends, to the S-GW 104, a Modify Bearer Request message that instructs the U-plane setting process in the S-GW 104 (912).

The S-GW 104 changes the U-plane setting that data is sent to the WiFi base station 106 to the setting that data is sent to the eNB 102, and sends a Modify Bearer Response message to the MME 103 (913).

After completing the processes up to the procedure 913, the U-plane is set in the state in which user data is transferred between the UE control unit 201, the eNB 102, and the S-GW 104 (914).

The MME 103 sends a UE Context Release Command message to the HeNB control unit 203 in order to notify that handover is completed through the WiFi base station 106 (915), and the HeNB control unit 203 sends a UE Context Release Complete message as the reply to the MME 103 through the WiFi base station 106 (916).

It is noted that it is necessary to cause both of the LTE wireless access system and the WiFi wireless access system to simultaneously communicate in the UE 101 in order to perform the procedure 915 and the procedure 916. It is considered that when both of the LTE wireless access system and the WiFi wireless access system simultaneously communicate, a battery is wasted, or an additional function to simultaneously cause both systems to communicate is necessary. Therefore, such a method may be possible in which SCTP connection is disconnected after sending the eNB Status Transfer message to the MME 103 in the procedure 908, so that the procedure 915 and the procedure 916 are omitted, and the LTE wireless access system and the WiFi wireless access system are not caused to simultaneously communicate at the UE 103.

It is noted that NAS signal processing and S1-AP processing applied in the present processes are operated in compliance with TS23.401, which is the 3GPP standard specification, as the handover process in the LTE wireless access system.

Moreover, RRC signal processing is applied between the UE control unit 201 and the HeNB control unit 203 as an example. However, as described above, communications between the UE control unit 201 and the HeNB control unit 203 are the operation in the UE 101, and the NAS signal may be transmitted with an original signal defined, not actually applying RRC.

What is claimed is:

1. A mobile terminal comprising:
a first wireless processing unit having a function to communicate with a first wireless access system;
a second wireless processing unit having a function to communicate with a second wireless access system; and
a terminal control unit configured to determine whether to use the first wireless processing unit or the second wireless processing unit and to control a function as a wireless terminal, wherein:
the mobile terminal further includes a base station functional unit, the base station functional unit having a communication protocol processing function of a base station of the first wireless access system; and
based on control of the terminal control unit, a signal generated at the base station functional unit, the signal being based on a communication protocol of the base station in the first wireless access system, is stored in a radio signal of the second wireless access system at the second wireless processing unit, and the signal is sent to a device in a core network of the first wireless access system via the second wireless access system.

2. The mobile terminal according to claim 1, wherein:
the first wireless access system is a wireless access system according to an LTE wireless mode;
the second wireless access system is a wireless access system according to a WiFi wireless mode; and
in call establishment, a call establishment signal of a NAS signal generated at the terminal control unit is encapsulated at the base station functional unit using an SI-AP protocol and an SCTP protocol, the call establishment signal is stored in a WiFi wireless frame at the second wireless processing unit, and the call establishment signal is sent to a device in a core network via a WiFi base station.

3. The mobile terminal according to claim 1, wherein:
the first wireless access system is a wireless access system according to an LTE wireless mode;
the second wireless access system is a wireless access system according to a WiFi wireless mode; and
in data communications after establishing connection, an IP packet generated at the terminal control unit is encapsulated at the base station functional unit using a GTP-U protocol, the IP packet is stored in a WiFi wireless frame at the second wireless processing unit, and the IP packet is sent to a device in EPC via a WiFi base station.

4. A wireless communication system comprising:
a base station configured to communicate with a mobile terminal;
mobility management equipment configured to control call establishment from the base station;
a home subscriber server configured to perform an authentication process for subscriber information about the mobile terminal;
a gateway to a wireless access network; and
a gateway to a service network, wherein:
the wireless communication system further includes:
a second base station according to a wireless mode different from a wireless mode between the base station and the mobile terminal connected to the mobility management equipment via the Internet; and
a mobile terminal having a communication protocol processing function of the base station and a wireless processing function to communicate with the second base station and configured to store a signal that uses a communication protocol of the second base station in a wireless frame that uses a wireless mode and send the signal to the mobility management equipment via the second wireless base station and the Internet.

5. The wireless communication system according to claim 4, wherein:
the mobility management equipment performs an authentication process, an encryption process, and a decryption process for processing a call establishment signal; and
the gateway to the wireless access network performs an encryption process and a decryption process for processing user data.

6. The wireless communication system according to claim 4, wherein:
the second base station is configured to connect to the mobility management equipment through a serving gateway; and
the serving gateway performs an authentication process, an encryption process, and a decryption process for processing a call establishment signal and an encryption process and a decryption process for processing user data.

7. A wireless communication method for a wireless communication system including a first wireless access system and a second wireless access system, wherein:
a mobile terminal has a protocol communication function of a base station of the first wireless access system;
the mobile terminal stores a signal generated using a protocol of the base station of the first wireless access system in a wireless frame of the second wireless access system, and sends the signal to a base station of the second wireless access system;
the base station of the second wireless access system is a base station connected to the Internet, and transfers the received signal to a core network device of the first wireless access system via the Internet; and
the core network device of the first wireless access system performs call establishment processing and user data processing via the base station of the second wireless access system and the Internet, as similar to the mobile terminal communicating with the base station of the first wireless access system using the protocol communication function of the base station, the mobile terminal having the protocol communication function of the base station of the first wireless access system.
